(19) United States
(12) Patent Application Publication
(10) Pub. No.: US 2005/0110193 A1
(43) Pub. Date: May 26, 2005

(54) Composition for making polymeric linings

(75) Inventor: Paul Schnarr, Salt Lake City, UT (US)

Correspondence Address: MORRISS O'BRYANT COMPAGNI, P.C., 136 SOUTH MAIN STREET, SUITE 700, SALT LAKE CITY, UT, 84101, US

(73) Assignee: EnviroTech Pumpsystems, Inc.

(21) Appl. No.: 10/997,579

(22) Filed: Nov. 24, 2004

Related U.S. Application Data
(60) Provisional application No. 60/525,308, filed on Nov. 26, 2003.

(51) Int. Cl. B29C 63/00; B05D 3/02

(52) U.S. Cl. 264/316; 427/385.5; 106/14.05

(57) ABSTRACT

Polymeric compounds are disclosed for use in making hand-layable linings for pumps, pump parts and other industrial fluid processing equipment used for processing abrasive slurries or corrosive fluids. The polymeric compounds of the present invention have improved handling, flexibility and adherence characteristics which facilitate the making of hand-laid linings and improve the adherence and durability of such linings.

### CROSS-REFERENCE TO RELATED APPLICATION

This application is a non-provisional application claiming priority to provisional patent application Ser. No. 60/525,308 filed Nov. 26, 2003.

### BACKGROUND OF THE INVENTION

1. Field of the Invention

This invention relates to industrial equipment for processing abrasive and/or corrosive liquids and slurries, and specifically relates to compositions for forming linings for industrial processing equipment, such as pumps, pump parts and pipes.

2. Description of Related Art

Many industries involve the processing of slurries or corrosive fluids, including the mining, wastewater and pulp and paper industries. Slurries generally comprise liquid compositions containing solids where the solids are abrasive. Corrosive fluids are those which contain acidic or caustic materials, though not necessarily abrasive solids. Some slurries may be corrosive as well as abrasive. Industrial equipment used for processing slurries, such as slurry pumps, or corrosive fluids are made of hard metal materials to, in part, withstand the deleterious effects of the fluids being processed. Nonetheless, processing abrasive or corrosive fluids tends to wear on certain parts or areas of the equipment and eventually causes severe deterioration of the interior surfaces of the equipment.

It is common, therefore, in the manufacture of industrial processing equipment to provide such equipment with a lining or protective covering that can take the wear caused by processing abrasive or caustic fluids. When the liner or covering becomes worn or deteriorated from extended exposure to such fluids, the lining or covering can be replaced, thereby protecting the metal of the pump or pump parts from damage.

Compositions of elastomeric or polymeric material used for making linings for industrial equipment are vast and well-known. Natural rubber is perhaps the most prevalently used material for slurry processing equipment because of its excellent resistance to abrasion. Natural rubber is less resistant to high temperatures or corrosive conditions, however. Known natural rubber and certain polymeric materials also provide fairly ideal characteristics for the molding of linings.

Known compositions are usually formulated for making linings by well-known methods, such as molding. It is also well-known, however, that many compositions have molding characteristics that do not lend themselves well to the special requirements of lining or covering some types or configurations of industrial equipment. That is, for example, some slurry equipment have sharp edges, acute angles or seams between adjacent elements of the equipment (e.g., pump casing parts) where conventional elastomeric and polymeric linings do not mold well to the surface of such areas. Conventionally molded linings fail in those areas because the lining material cannot adhere well to the configuration and/or surface characteristics of the equipment.

Slurry pumps, for example, are manufactured from separate casing elements (e.g., side liner casings and volute casings) that are seamed together. Slurry pumps may also be manufactured with certain volute configurations to maximum the pumping efficiency of the pump. The particular configuration of the pump may have acute angles or sharp edges that make it very difficult to produce a molded lining to fit those areas of the pump casing or which make it difficult for the molded lining to adhere to the surface of such areas. The seams between adjoining casing elements often present a particular problem area for adherence of molded linings to the casing.

In operation, when a molded lining does not adhere properly to the acute angles, seams or other areas of the equipment, the lining deteriorates significantly in those areas and eventually fails. The lining must then be replaced. In order to produce better adherence of the linings to the casing, the polymeric composition may be hand laid to the hard edges or acute angles of the equipment.

However, known polymeric compositions used for producing linings are not suitable for hand laying because they do not adhere adequately to the angled or hard-edge portions of equipment and the material is not sufficiently flexible to be handled in such areas of the equipment. Additionally, when working with conventional compositions for hand-laying the lining, a great deal of scrap material (i.e., unusable product) results in the attempt to achieve a lining that will fit or adhere for the intended purpose.

Thus, it would be advantageous in the art to provide a polymeric composition that is suitable for use in making linings for industrial equipment, such as slurry pumps, pump parts and pipes, that will withstand the abrasive or caustic environment of fluids slurry processing and provide a comprehensive adherence of the lining to the metal surface of the equipment. It would further be advantageous to provide such compositions that are capable of being hand laid and which, in their production, reduce the amount of scrap material produced in the process of making linings.

### BRIEF SUMMARY OF THE INVENTION

In accordance with the present invention, a composition for polymeric material is provided which is suitable for use in making linings for slurry processing equipment, and which is suitable for hand laying of the lining to produce a comprehensive adherence of the lining to the equipment. The composition has excellent wear resistance in abrasive and/or caustic environments.

The compositions of the present invention generally comprise polymers having a high resistance to caustic or corrosive conditions and high temperature, as compared with natural rubber. The polymers are also sufficiently flexible to facilitate the hand laying and adherence of the lining to surfaces that have acute angles, or which are otherwise difficult to line or cover by conventional molded linings. The polymers used in the compositions of the present invention are also selected to facilitate the manufacture of the linings by virtue of their ability to be formed into multiple sheets which effectively eliminate holes in the lining material.

Particularly suitable polymers include chlorinated polymers, such as the chlorosulfonated polyethylene material sold by Dupont Dow Elastomers, Inc. of Wilmington, Del. under the trademark Hypalon®. Other polymers may be equally suitable for use in the compositions of the present invention.

The compositions of the present invention exhibit better resistance to acidic or caustic environments than natural rubber and are suitable for use in conditions where abrasion resistance is required. The compositions, while being more difficult to work with than natural rubber due to their increased thermoplasticity, nonetheless facilitate the production of linings because of reduced blistering and/or delamination as compared with other polymeric compositions. The compositions also exhibit improved tackiness over conventional lining compositions which enable the linings of the present invention to adhere better to acute angles and difficult-to-line surfaces.

The compositions are most suitably produced into sheets which may then be layered to produce a sheet of lining material that is of the desired thickness. Because of the improved characteristics of the compositions of the present invention, multilayering of the material enables the production of linings that are devoid of holes or openings of sufficient size to allow caustic liquids therethrough.

The compositions of the present invention are directed especially to the production of linings that facilitate hand-laying in those areas or surfaces of equipment that are difficult to line by conventional molded linings or to which conventional molded linings tend not to adhere. However, the compositions of the present invention may also be formed into linings using conventional molding methods known in the industry. Linings may also be made from the compositions by extrusion or other methods.

### DETAILED DESCRIPTION OF THE INVENTION

The compositions of the present invention comprise a polymer which exhibits high resistance to caustic or corrosive fluids and high temperatures, and which are highly resistant to abrasion from, from example, abrasive slurries. A general formulation of the composition of the present invention is shown in Example I, below.

### EXAMPLE I

| Constituent | Percent in Formula | Representative Product (Manufacturer) |
|---|---|---|
| Carbon Black | 25%-35% | Thermax FloForm N990 (Cancarb) |
| Polymer Resin | 6%-10% | Novares C10 [Coumarone-Indene-Resin] |
| Lubricant | 0.5%-2.5% | Stan-Wax GKD (Harwick Standard) |
| Accelerator | 0.01%-1.5% | MBTS (ElastoChem Division) and |
| | | Sulfads (ElastoChem Division) |
| Vulcanizer/Activator | 8%-15% | AkroMag-green (AkroChem) [MgO] |
| Chlorosulfonated | 40%-50% | Hypalon ® 40 (Dupont Dow) |
| polyethylene | | |

A presently preferred formula is as follows:

| | |
|---|---|
| Carbon Black (Thermax FloForm N990) | 31.39% |
| Polymer Resin (Novares C10) | 8.05% |
| Stan-Wax GKD | 1.79% |
| MBTS | 0.22% |
| Sulfads (ElastoChem Division) | 0.90% |
| AkroMag-green (Vulcanizer) | 12.81% |
| Chlorosulfonated polyethylene (Hypalon ® 40) | 44.84% |

The composition is formed by mixing all of the constituent elements of the formula together at approximately 200° F. in an appropriate mixer, such as a Banbury mixer. The material may be formed by conventionally known machinery that mixes and kneads the ingredients until a homogeneous composition is produced (between two minutes and thirty minutes). The material may then be dropped on a mill and sheeted off using known methods, such as handling through a calendering process. The compositions of the present invention enable sheets to be made which have reduced surface bubbling or blistering as compared with other polymeric compositions.

Individual sheets of the material may then be layered to a desired thickness for producing the lining. Layering the sheets of the material has the added value of reducing the existence of any tiny holes or openings through which slurry and/or caustic fluid may flow to cause delamination of the lining. The composition thus formed is suitable for making linings for hand laying the material on surfaces of processing equipment.

The lining may be hand laid by known techniques, which generally comprise applying a sheet of material to the surface to be lined and pressing against the surface until adherence of the material to the surface is achieved. The compositions of the present invention exhibit a higher level of tackiness that enables the material to adhere to the surface better than other polymeric compositions. Because the present compositions provide improved tackiness, there is less waste resulting from reapplication of linings that don't adhere, which is commonly experienced with other lining materials. Consequently, there is less scrap material than with other lining materials, which represents a considerable cost savings.

Once the lining is applied to the surface, the lining is cured. One exemplary means of curing the material is to place the lined object into an autoclave at a heat and for a time sufficient to harden the material. For example, the lining may be cured in an autoclave at a temperature of from between about 250° F. to about 320° F. for a time period of from between about one to four hours. Times and temperatures for curing may vary depending on the thickness of the lining and the size of the surface being lined.

While the compositions disclosed herein are most particularly suitable for use in hand laying linings or coverings in or on non-linear surfaces as described, the compositions may also be formed into molded linings by processes well known in the art of making molded linings. Linings may also be made by extruding the composition from an extrusion machine to a size or dimension required for the particular application.

The compositions produced by the formula produce a polymeric material which can be hand laid on surfaces where linings are known to fail, such as seams and acute angles, and the material bonds to the surface of the equipment better than conventional polymeric lining material. The composition and material of the present invention also reduces the amount of scrap material that results from the formation of linings and, therefore, significantly reduces the cost of manufacturing linings. The compositions of the present invention can be adapted for use in lining or covering processing equipment other than slurry processing equipment. Thus, reference herein to details of the invention are by way of example and not by limitation.

1. A composition for making linings or coverings for industrial fluid processing equipment, comprising:
carbon black in an amount by weight of between 25% and 35%;
polymer resin in an amount by weight of between 6% and 10%;
a suitable lubricant in an amount by weight of between 0.5% and 2.5%;
at least one accelerator in an amount by weight of between 0.01% and 1.5%;
a vulcanizing agent in an amount by weight of between 8% and 15%; and
a polymer in an amount by weight of between 40% and 50%, said polymer being highly resistant to caustic or acidic fluids and high temperatures, being sufficiently flexible to be hand laid on equipment surfaces and having increased tackiness to adhere to equipment surfaces.

2. The composition of claim 1 wherein said polymer is a chlorinated polymer.

3. The composition of claim 2 wherein said polymer is chlorosulfonated polyethylene.

4. A polymeric lining or covering for metal surfaces of slurry processing equipment made from the composition as set forth in claim 1.

5. The polymeric lining or covering of claim 4 wherein said lining or covering is formed into a sheet of one or more layers.

6. The polymeric lining or covering of claim 4 wherein said lining or covering is formed by molding.

7. The polymeric lining or covering of claim 4 wherein said covering or lining is formed by extrusion.

8. The polymeric lining or covering of claim 5 wherein said lining or covering is formed by a calendering process.

9. A polymeric lining or covering for metal surfaces of industrial fluid processing equipment, comprising a polymeric covering for metal surfaces having high resistance to acidic or caustic fluids and high temperatures, and being sufficiently flexible and tacky to enable the hand laying and adherence of the covering to surfaces that have acute angles or which are otherwise difficult to line or cover by conventional molded linings.

10. The polymeric lining or covering of claim 9 wherein said covering or lining is formed into a sheet of material comprising one or more layers of polymeric material.

11. The polymeric lining or covering of claim 9 wherein said covering or lining is formed by molding.

12. The polymeric lining or covering of claim 9 wherein said covering or lining is formed by extrusion.

13. A method of lining non-linear surfaces of processing equipment, comprising:
providing a polymeric material comprising:
carbon black in an amount by weight of between 25% and 35%;
polymer resin in an amount by weight of between 6% and 10%;
a suitable lubricant in an amount by weight of between 0.5% and 2.5%;
at least one accelerator in an amount by weight of between 0.01% and 1.5%;
a vulcanizing agent in an amount by weight of between 8% and 15%; and
a polymer in an amount by weight of between 40% and 50%, said polymer being highly resistant to caustic or acidic fluids and high temperatures, being sufficiently flexible to be hand laid on equipment surfaces and having increased tackiness to adhere to equipment surfaces;
forming said polymeric material into a flexible member;
applying said flexible member to a non-linear surface of processing equipment; and
curing said flexible member.

14. The method of claim 13 wherein said flexible member is formed into a sheet of one or more layers and is applied by hand.

15. The method of claim 13 wherein said flexible member is formed by molding.

16. The method of claim 13 wherein said flexible member is applied by hand laying.
